(19) United States
(12) Patent Application Publication
(10) Pub. No.: US 2024/0305035 A1
(43) Pub. Date: Sep. 12, 2024

(54) MODULAR SEQUENTIAL MATING ELECTRICAL CONNECTOR SYSTEM

(71) Applicant: Aptiv Technologies AG, Schaffhausen (CH)

(72) Inventors: Jeffrey S. CAMPBELL, West Bloomfield, MI (US); Wesley W. WEBER, JR., Lapeer, MI (US)

(21) Appl. No.: 18/595,734

(22) Filed: Mar. 5, 2024

Related U.S. Application Data
(60) Provisional application No. 63/450,463, filed on Mar. 7, 2023.

(51) Int. Cl. H01R 13/514; H01R 43/20

(52) U.S. Cl. CPC H01R 13/514; H01R 43/20

(57) ABSTRACT

An electrical connection system is described that includes a module interface, a first terminal module, and a second terminal module. The first terminal module is configured to be retained in the module interface. The second terminal module is configured to be retained adjacent to the first terminal module in the module interface, secured in a predefined position staggered relative to the first terminal module. The module interface is configured to be seated on a header interface and moved relative to the header interface until the first terminal module is mated. The module interface is configured to be released once the first terminal module is mated and moved to a fully seated position on the header interface, which mates the second terminal module and locks the module interface to the header interface.

This application is a non-provisional application that claims priority to provisional application 63/450,463 titled “MODULAR SEQUENTIAL MATING ELECTRICAL CONNECTOR SYSTEM,” filed Mar. 7, 2023, the entire contents of which are incorporated herein by reference.

### TECHNICAL FIELD OF THE INVENTION

The invention generally relates to electrical connectors, and more particularly electrical connectors for coupling multiple high speed data terminals.

### BACKGROUND

Electrical connectors are commonly used in automotive vehicle systems to couple electrical components and systems to one another. For example, a vehicle electrical system may include one or more wiring harnesses that carry cables terminated by terminals used for connection to components of a vehicle electrical system.

Recent vehicles incorporate more and more complex electrical systems that require data to be transferred at higher speeds than traditional automotive cabling, examples of which include coaxial, twisted pair wire, and other high-speed data cables.

In some examples, it may be desirable to couple many high-speed data cables together simultaneously, in order to reduce a cost and/or complexity of vehicle assembly processes. A need exists for electrical connectors that are capable of supporting the simultaneous coupling of multiple-high speed data terminals that is relatively inexpensive to manufacture, easy for an operator to assemble, and/or resilient to unintended decoupling.

### SUMMARY

An electrical connector is described that provides for the coupling of multiple high-speed data cables simultaneously that is relatively easy and inexpensive to manufacture and connect as part of a vehicle assembly process. The described connector may further be particularly resilient to intended disconnection in comparison to other connectors.

In some aspects, an electrical connection system is described. The electrical connection system includes a module interface, a first terminal module configured to be retained in the module interface, and a second terminal module configured to be retained adjacent to the first terminal module in the module interface, locked in a predefined position staggered relative to the first terminal module. The module interface is configured to be seated on a header interface, and moved relative to the header interface until the first terminal module is mated. The module interface is further configured to be released once the first terminal module is mated to the header interface and moved to a fully seated position on the header interface, which mates the second terminal module and locks the module interface to the header interface.

In other aspects, a method is described. The method includes retaining a first terminal module in a module interface. The method further includes retaining a second terminal module in the module interface locked in a predefined position in the module interface staggered relative to the first terminal module. The method further includes seating the module interface on a corresponding header interface. The method further includes moving the module interface relative to the header interface until the first terminal module is mated. The method further includes mating the first terminal module, thereby releasing the module interface to move relative to the header interface. The method further includes moving the module interface to a fully seated position on the header interface, which mates the second terminal module and engages a lock to secure the module interface to the header interface.

In some aspects, a module interface is described. The module interface includes a first module channel configured to retain a first terminal module in the first terminal channel, and a second module channel configured to retain a second terminal module in the second terminal channel, locked in a predefined position longitudinally staggered relative to the first terminal module in the module interface. The module interface is configured to be arranged on a header interface, and moved relative to the header interface until the first terminal module is mated. The module interface is configured to be released once the first terminal module is mated to the header interface and moved to a fully seated position on the header interface, which mates the second terminal module and locks the module interface to the header interface.

### BRIEF DESCRIPTION OF THE DRAWINGS

The present invention will now be described, by way of example with reference to the accompanying drawings, in which:

FIG. 1 is a perspective view showing one example of an electrical connection system according to some embodiments.

FIG. 2A is an exploded view showing components of an electrical connection system according to some embodiments.

FIG. 2B is an exploded view showing an opposite side of the electrical connection system components depicted in FIG. 2A according to some embodiments.

FIG. 3A is a perspective view showing a module interface of an electrical connection system according to some embodiments.

FIG. 3B is a perspective view showing an opposite side of the module interface depicted in FIG. 3A according to some embodiments.

FIG. 4A is a perspective view showing a header interface of an electrical connection system according to some embodiments.

FIG. 4B is a perspective view showing an opposite side of the header interface depicted in FIG. 4A according to some embodiments.

FIG. 5A is a perspective view showing an electrical connection system prepared to be seated on a header interface according to some embodiments.

FIG. 5B is a perspective view showing an electrical connection system seated on a module interface arranged on a header interface according to some embodiments.

FIG. 5C is a perspective view showing an electrical connection system with the module interface fully seated on the header interface according to some embodiments.

FIG. 6A is a cross section view showing an electrical connection system in a pre-seated position on the header interface according to some embodiments.

FIG. 6B is a cross section view showing an electrical connection system with a module interface fully seated on the header interface according to some embodiments.

FIG. 7 is a flow diagram that depicts one example of a method according to some embodiments.

### DETAILED DESCRIPTION

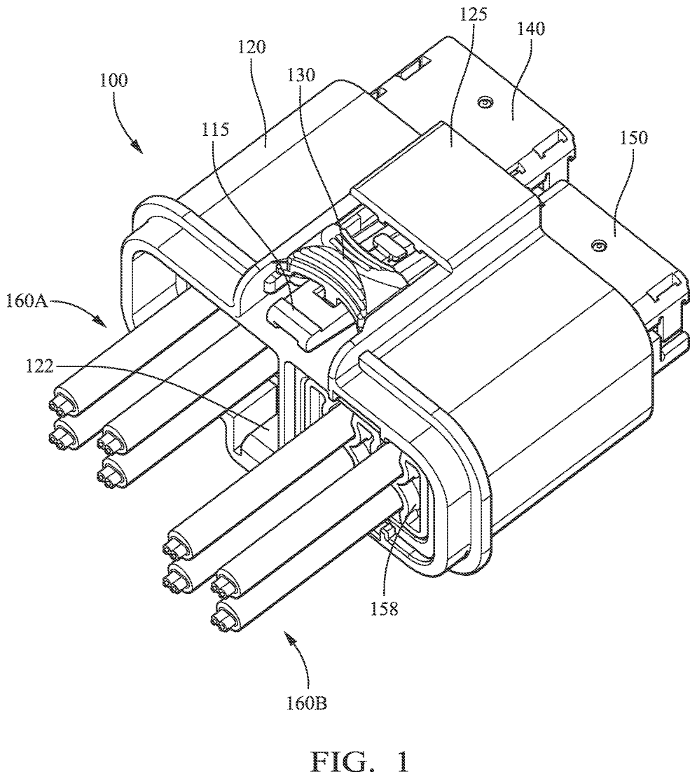

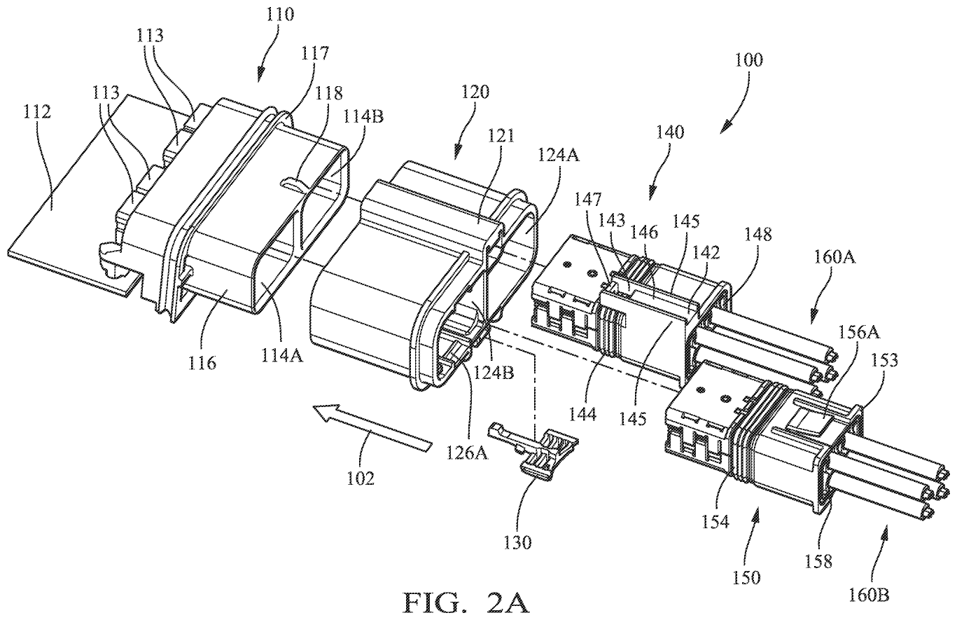

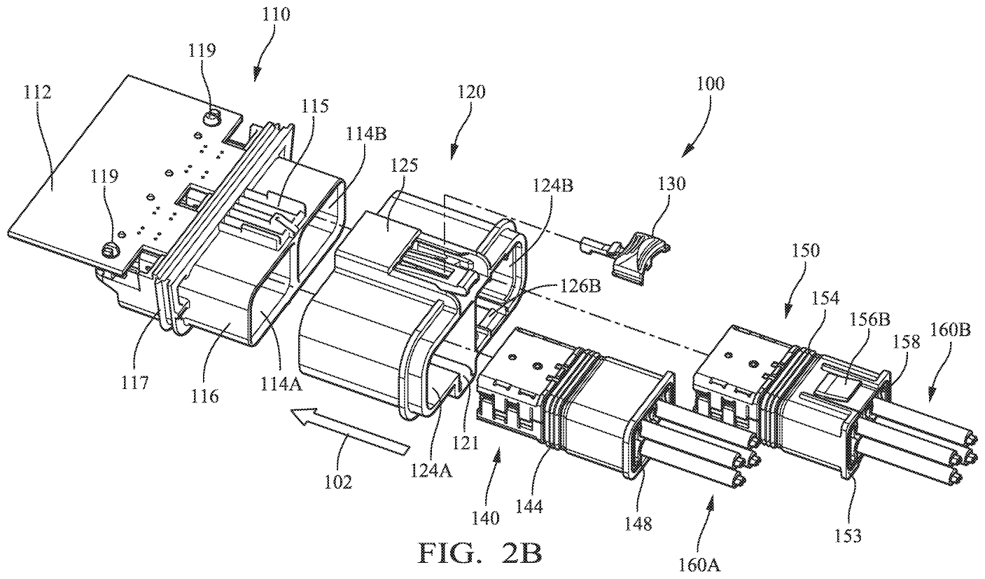

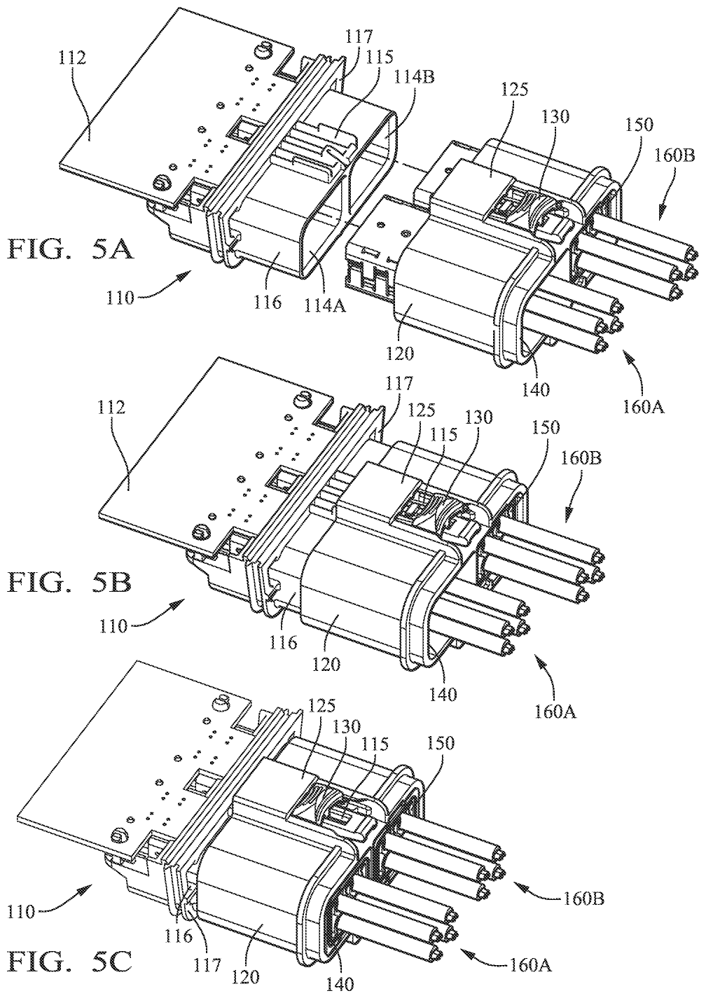

FIG. 1 is a perspective view showing one example of an electrical connection system 100 according to some embodiments. In the example of FIG. 1, the connection system 100 has been assembled in preparation for mating with a corresponding header interface 110 (as shown in FIG. 5A and described in further detail below). FIG. 2A is an exploded view showing components of the connection system 100 according to some embodiments. FIG. 2B is an exploded view showing an opposite side of the connection system 100 components depicted in FIG. 2A according to some embodiments.

The connection system 100 includes a module interface 120, a first terminal module 140, and a second terminal module 150. As shown in FIG. 1, the first and second terminal modules 140, 150, are each configured to carry terminals (not shown) that terminate a plurality of cables 160A, 160B, which may be high-speed data terminals such as coaxial, twisted-pair, or other types of high-speed data terminals. In the specific example of FIG. 1, terminal module 140 carries four terminals (not shown) that terminate four cables 160A, and terminal module 150 also carries terminals that terminate four cables 160B. In other examples, one or more of terminal module 140, 150 may carry a different number of terminals that terminate a different number of cables for mating. As shown in FIGS. 2A and 2B, the first terminal module 140 includes a plurality of terminal stablilizer features 148 that support terminals (not shown) and/or cables 160A, and the second terminal module 150 includes a plurality of terminal support features 158 that support terminals (not shown) and and/or cables 160B.

The module interface 120 is configured to retain the first terminal module 140 and the second terminal module 150 to facilitate mating and locking the first and second terminal modules 140, 150 to a corresponding interface, such as header interface 110. In some examples, the module interface 120 is configured to retain the first terminal module 140 differently than the second terminal module 150 is retained for mating. In some examples, the module interface 120 is configured to support the respective terminal modules 140, 150 staggered in the module interface 120, such that the terminal modules 140, 150 are mated in sequence, by first mating the first terminal module 140, and then mating the second terminal module 150, when the module interface 120 is seated on a header interface 110 and moved to a fully seated position on the header interface 110.

In some examples, traditional electrical connection systems configured to connect a large number of terminals may require a significant insertion force to be mated, which may be more than a force recommended for a human or machine operator. In some examples, such traditional electrical connectors may include an additional mate assist feature, such as a lever or other geared feature configured to a lower an exertion force needed for mating the terminals.

In some examples, the connection system 100 may be useful to mate a large number of terminals at one time, but without requiring a mate assist features as described above. For example, by arranging the terminal modules 140, 150 to be sequentially mated, the insertion force required to connect the terminals can be distributed across the respective terminal modules, which may in some examples cut in half the insertion force needed to mate the connection system 100. In some examples, connection system 100 may be relatively easy and/or inexpensive to manufacture in comparison with traditional connection systems that employ a mate assist feature as described above.

In the examples shown, a connection system 100 is depicted that includes two terminal modules 140, 150, that are secured differently from one another in the module interface 120, and staggered relative to one another to support sequential mating. In other examples not depicted, connection system 100 may carry more terminal modules than shown that are configured as either a first terminal module 140, or a second terminal module 150. For example, a connection system 100 may include a second terminal module 150, and a pair of first terminal modules 140 staggered relative to the second terminal module 150 to support sequential mating of all three terminal modules. In other examples, a connection system 100 may alternate between second terminal modules 150 and first terminal modules 140, staggered relative to another, in rows. In some such examples, the connection system 100 may include any combination of first and second terminal modules 140, 150 arranged in two, three or more rows, with each row staggered relative to other rows to distribute an insertion force required to mate the connection system 100 across multiple terminal modules.

In some examples, distributing the insertion force across multiple terminal modules 140, 150 as described may enable terminal modules 140, 150 that carry more terminals than shown for mating. For example, although not depicted, terminal module 140, 150 may support more than the four terminals shown, for example, 8, 16, or even 32 terminals may be carried by each terminal module 140, 150 to be mated.

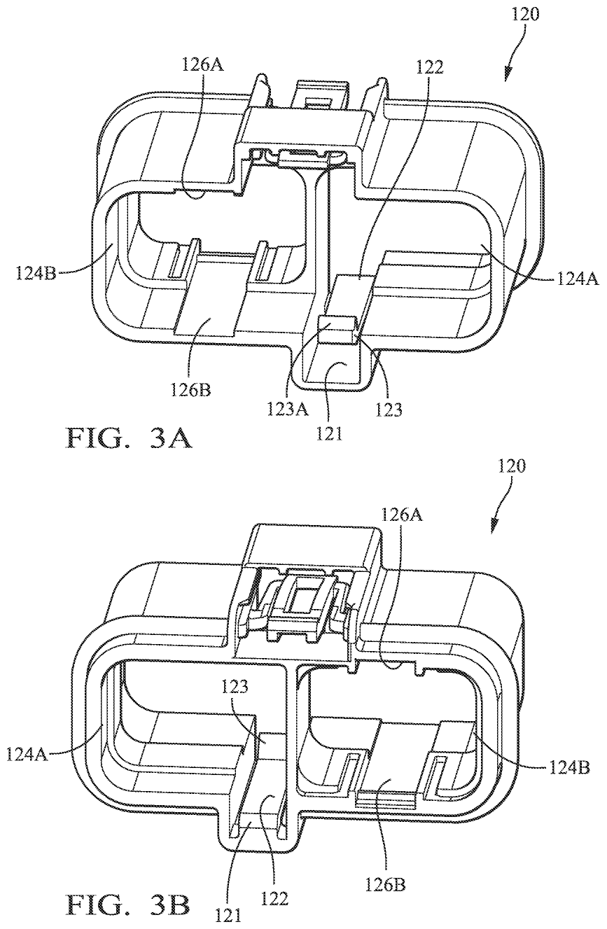

FIG. 3A is a perspective view showing a module interface 120 according to some embodiments. FIG. 3B is a perspective view showing an opposite side of the module interface 120 depicted in FIG. 3A according to some embodiments.

The module interface 120 includes module channels 124A and 124B. Module channel 124A is configured to retain terminal module 140, and module channel 124B is configured to retain terminal module 150 adjacent to terminal module 140. Module channel 124A and the first terminal module 140 each include features configured to engage such that the first terminal module 140 is retained in the module interface 120. As shown in FIGS. 2A and 2B, the first terminal module 140 includes a mating feature 142 configured to engage with a corresponding mating channel 121 defined in the module channel 124A. As also shown in FIGS. 2A and 2B, the first terminal module 140 may also include an optional seal 144.

The module interface 120 and the second terminal module 150 are configured such that the second terminal module 150 is retained in the module interface 120 locked in a predefined position in the module interface 120. For example, referring to FIGS. 2A and 2B, the second terminal module 150 includes a pair of lock features 156A, 156B on opposed sides of the second terminal module 150 that are configured to engage with corresponding lock features 126A, 126B, respectively, on opposed sides of the module channel 124B to retain the second terminal module 150 locked in a predefined position in the module channel 124B. In some examples, the second terminal module 150 may be described as locked in a predefined position, fixed relative to a longitudinal axis through the module channel 124B of the module interface 120, which corresponds to an insertion direction 102 in which second terminal module 150 is inserted into the module channel 124B. As also shown in FIGS. 2A and 2B, the second terminal module 150 may also include an optional seal 154.

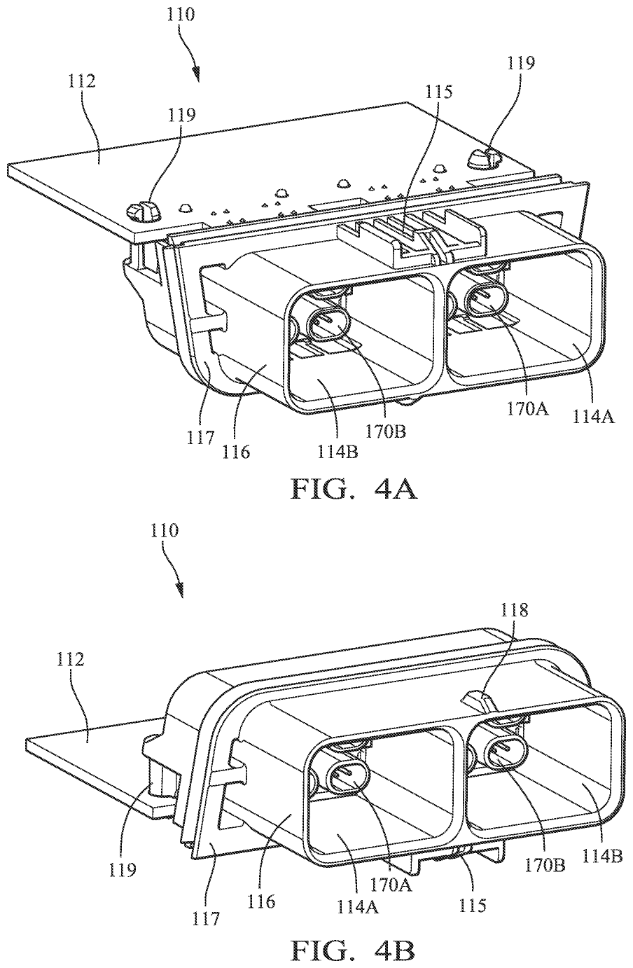

FIG. 4A is a perspective view showing a header interface of an electrical connection system according to some embodiments. FIG. 4B is a perspective view showing an opposite side of the header interface depicted in FIG. 4A according to some embodiments. As shown in FIGS. 4A and 4B, the header interface 110 is configured to facilitate electrical connections to one or more components (not shown), mounted on a printed circuit board (PCB) 112. The header interface 110 is coupled to the PCB 112 by a pair of bolts 119 and includes a pair of openings 114A, 114B surrounded by a collar 116. The openings 114A, 114B correspond to the terminal modules 140, 150 and carry corresponding terminals 170A, 170B respectively, for mating with terminals (not shown) carried by the terminal modules 140, 150. For example, each of the openings 114A, 114B in the depicted example facilitate access to four terminals, which correspond to the four terminals carried by each of the terminal modules 140, 150. Referring back to FIG. 2A, the terminals carried by header interface 110 are coupled by vertical conductors 113 to the PCB 112 (e.g., to traces or other conductive structures on or in the PCB 112, not shown).

As shown in FIGS. 4A and 4B, the collar 116 extends from a ledge 117 and is configured for module interface 120 to be seated on the collar 116 for mating. The collar includes a lock feature 115 that corresponds to lock feature 125 of the module interface on a first outer surface, and a raised protrusion 118 with an angled surface 118A on a second outer surface.

Referring to FIGS. 2A and 2B, to assemble the module interface 120 for mating as depicted in the FIG. 1, the second terminal module 150 is inserted in module channel 124B, and moved longitudinally forward (in insertion direction 102) until lock features 156A and 156B engage corresponding lock features 126A, 126B in the module channel 124B to lock the second terminal module 150 in the predefined position.

In addition, the first terminal module 140 is inserted into the module channel 124A of the module interface 120, and moved longitudinally forward (in insertion direction 102) into the module channel 124A, with engagement end 123 of elongate spring 122 engaged with mating feature 142 (e.g., with engagement end 123 of elongate spring 122 between rails 145, on raised portion 146). The first terminal module 140 may be moved longitudinally forward, in the insertion direction 102, until the engagement end 123 reaches the recessed portion 143 and snaps into the recessed portion 143, which movably secures the first terminal module 140 in the module channel 124 (i.e., with limited travel of the engagement end 123 in the recessed portion 143).

With the first and second terminal modules 140, 150 secured in the module interface 120, staggered as shown, the module interface 120 may be seated on the header interface 110, for example on a collar 116 of the header interface 110, and moved relative to (e.g., towards) the header interface 110 to first mate the first terminal module 140, and then mate the second terminal module 150.

FIGS. 5A-5C show the module interface 120 being coupled to a header interface 110 according to some embodiments. FIG. 5A is a perspective view showing module interface 120 assembled as shown in FIG. 1 and prepared to be seated on a header interface 110 according to some embodiments. According to the example of FIG. 5A, the first terminal module 140 is movably secured, with limited travel in the insertion direction 102, in the module interface 120 (e.g., in module channel 124A), for example with engagement end 123 of module channel 124A engaged with the recessed portion 143 of mating channel 121. When assembled as shown in FIG. 5A, the second terminal module 150 is retained in the module interface 120 adjacent to the first terminal module 140 (e.g., in module channel 124B), locked (via lock features 156A, 156B engaged with lock features 126A, 126B) in a predefined position staggered (i.e., longitudinally, in the insertion direction 102) relative to the first terminal module 140.

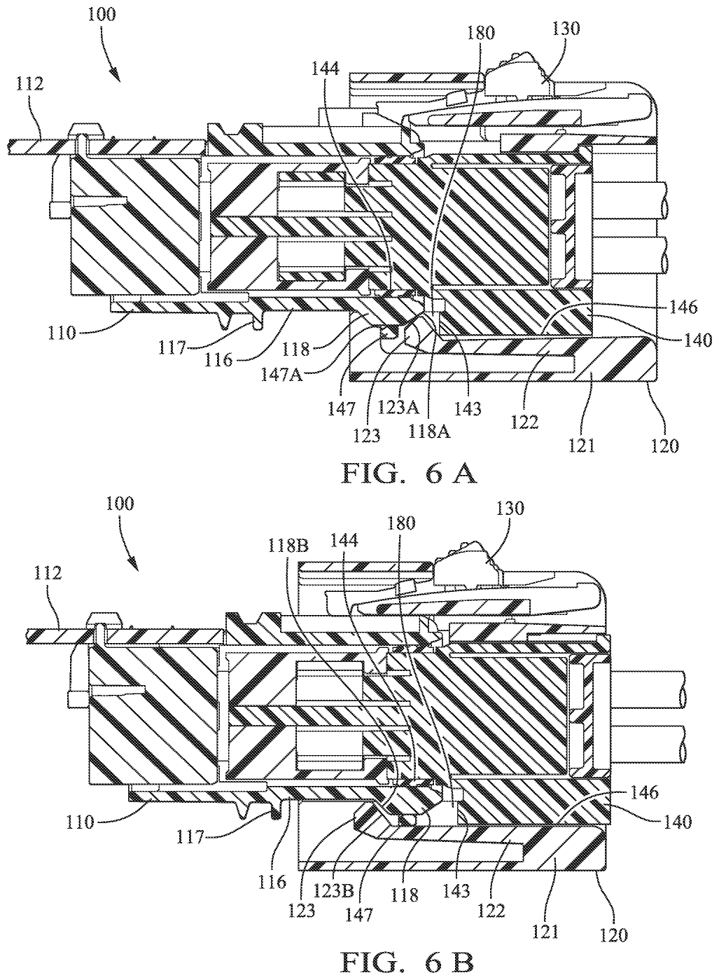

FIG. 5B is a perspective view showing an electrical connection system 100 with a module interface 120 seated on header interface 110 (e.g., on collar 116), according to some embodiments. Once seated on the header interface 110 as shown in FIG. 5B, the module interface 120 may be moved relative to (e.g., longitudinally, in the insertion direction 102) the header interface 110 to a pre-seated position to mate the first terminal module 140, which releases the module interface 120 to move further relative to (e.g., towards) on the header interface 110 to a fully seated position, which mates the second terminal module 150, and locks the module interface 120 to the header interface 110 according to some embodiments. For example, referring to FIG. 6A, in the pre-staged position, protrusion surface 118A, which is angled, engages with surface 123A of engagement end 123. In the pre-staged position shown in FIG. 6A, protrusion 118 pushes elongate spring 122 downward and under stop 123, which releases module interface 120 to moved further relative to (e.g., towards) to the fully seated position shown in FIGS. 5C and 6B.

FIG. 5C is a perspective view showing an electrical connection system 100 with a module interface 120 in a fully seated position seated header interface 110 (e.g., on collar 116), according to some embodiments. FIG. 6A is a cross section view showing one example of a connection system 100 with a module interface 120 in a pre-seated position on a header interface 110 as shown in FIG. 5C, in some embodiments. FIG. 6B is a cross section view showing the module interface 120 of FIG. 6A in a fully seated position on a header interface 110 as shown in FIG. 5C, in some embodiments.

Referring to FIG. 6A, module interface 120 may be moved relative to (e.g., towards) on the header interface 110 until protrusion 118 engages with stop 147 of mating feature 142, with angled surface 118A engaged with ramp 147A, which guides protrusion 118 to the position shown in FIG. 6A, with protrusion 118 arranged between the stop 147 and the seal 144, with the angled surface 118A of the protrusion 118 against a first ramp 123A of the engagement end 123 in the pre-seated position. Moving the module interface 120 to the pre-seated position shown in FIG. 6A mates the first terminal module 140 (e.g., mates terminals carried by the first terminal module 140 with corresponding terminals 170A of the header unit opening 114A). Once the first terminal module 140 is mated, the module interface 120 is released (e.g., by protrusion 118 engaging engagement end 123 to move downward) to move further relative to (e.g., towards), with angled surface 118A engaged with ramp 123A on engagement end 123, which pushes the engagement end underneath the stop 147 and finally past the stop 147, with ramp 123B of the engagement end 123 engaged with angled surface 118B of protrusion 118B, as shown in FIG. 6B. In the fully seated position shown in FIG. 6B, the protrusion 118 is wedged into a void 180 between the engagement end 123, the stop 147, and the first terminal module 140, for example as shown engaging the optional seal 144. In the fully seated position shown in FIG. 6B, the engagement end 123 and the protrusion 118 are engaged, securing the first terminal module 140 to the module interface 120. In some examples, a distance that the protrusion travels into the void 180 from the pre-seated position shown in FIG. 6A to the fully seated position shown in FIG. 6B corresponds to a longitudinal distance (in the insertion direction 102) that the first terminal module 140 and the second terminal module 150 were staggered relative to one another in the module interface 120, when assembled prior to mating as shown in the FIG. 1 example.

Moving the module interface 120 to the fully seated position shown in FIG. 6 mates the second terminal module 150 (e.g., mates terminals carried by the second terminal module 150 with corresponding terminals 170B of the header unit opening 114B), and secures the first terminal module 140 in position in the module interface 120. Moving the module interface 120 to the fully seated position shown further causes lock features 115 and 125 to engage, thereby locking the first terminal module 140, the second terminal module 150, and the module interface 120 to the header interface 110 as shown in the example of FIG. 5C. As also shown in FIG. 5C, once the module interface 120 was moved to the fully seated position with lock features 115, 125 engaged, CPA 130 may be applied to the lock features 115, 125, which prevent the lock features 115, 125 from disengaging unless the CPA 130 is removed by an operator.

As described, connection system 100 may beneficially support the coupling of many terminals using a single connector, without the use of a mating assist feature, such as a lever lock, to reduce a mating force needed to mate the connection system. By carrying the respective terminal modules 140, 150 staggered to be mated one after the other when module interface 110 is seated and moved to a fully mated position on the header interface 110, a mating force needed to mate the connection system 100 is distributed across the terminal modules 140, 150, which may effectively halve the mating force needed to mate the connection system 100.

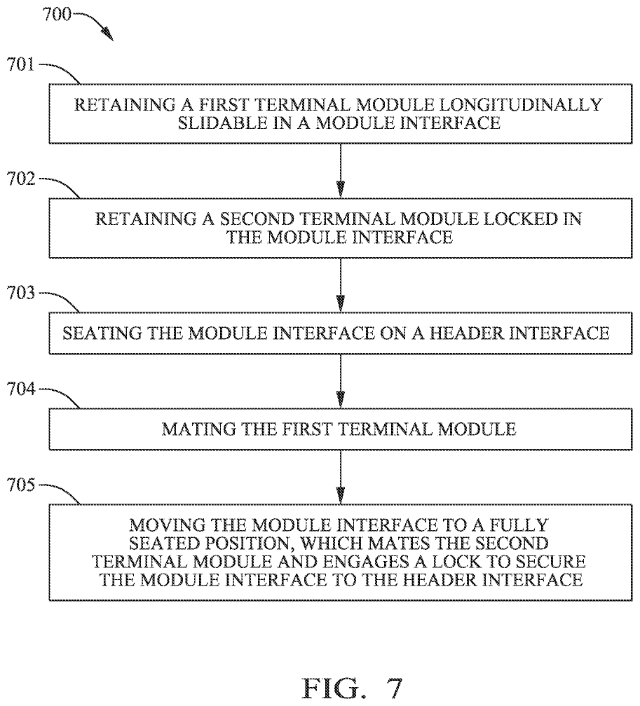

FIG. 7 is a flow diagram that depicts a method 700 of assembling an electrical connection system according to some embodiments. As shown in FIG. 7, at step 701, the method includes retaining a first terminal module (e.g., 140) in a module interface (e.g., 120). As also shown in FIG. 7, at step 702, the method includes retaining a second terminal module (e.g., 150) locked in the module interface, for example locked in a predefined position in the module interface staggered relative to the first terminal module. In some examples, the first terminal module and the second terminal module each carry a plurality of pairs of high-speed data terminals. In some examples, the method includes retaining the second terminal module 150 arranged longitudinally relative to (e.g., towards) (e.g., in an insertion direction 102 as shown in FIGS. 2A and 2B) of the first terminal module 140 in the module interface 120 before seating the module interface 120 on the header interface 110.

In some examples, the method further comprises engaging a mating feature (e.g., 142) of the first terminal module that engages with a mating channel (e.g., 121) defined in the module interface 120 to secure the first terminal module 140 in the module interface 120. In some examples, the mating feature includes a raised portion (e.g., 146), a recessed portion (e.g., 143), and a stop (e.g., 147). In some examples, the mating channel 121 includes an elongate spring (e.g., 122) with an engagement end (e.g., 123).

As also shown in FIG. 7, at step 703, the method further includes seating the module interface on a header interface (e.g., 110). As also shown in FIG. 7, at step 704, the method further includes mating the first terminal module, for example, by moving the module interface further onto the header interface to a pre-seated position on the header interface (e.g., as shown in FIGS. 5B and 6A). With the first terminal module mated, as also shown in FIG. 7, at step 705, the method further includes, moving the module interface to a fully seated position on the header interface (e.g., as shown in FIGS. C and 6B), which mates the second terminal module and engages a lock to secure the module interface to the header interface. For example, moving the module interface to a fully seated position on the header interface may cause a lock feature (e.g., 125) of the module interface to engage with a corresponding lock feature (e.g., 115) of the header interface to lock the module interface to the header interface. In some examples, the method further includes applying a connector position assurance (CPA) feature (e.g., 130) that engages with the first lock feature and the second lock feature to prevent the first and second lock features from disengaging.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An electrical connection system, comprising:
a module interface;
a first terminal module configured to be retained in the module interface;
a second terminal module configured to be retained adjacent to the first terminal module in the module interface, locked in a predefined position staggered relative to the first terminal module; and
wherein the module interface is configured to be seated on a header interface and moved relative to the header interface until the first terminal module is mated;
wherein the module interface is configured to be released once the first terminal module is mated and the module interface is moved to a fully seated position on the header interface, which mates the second terminal module and locks the module interface to the header interface.

2. The electrical connection system of claim 1, wherein the first terminal module and the second terminal module each carry a plurality of terminals.

3. The electrical connection system of claim 1, wherein the first terminal module is arranged forward of the second terminal module in the module interface before the module interface is seated on the header interface.

4. The electrical connection system of claim 1, wherein the first terminal module engages with the header interface to release the module interface once the first terminal module is mated.

5. The electrical connection system of claim 1, wherein the first terminal module includes a mating feature that engages with a mating channel defined in the module interface to release the module interface once the first terminal module is mated.

6. The electrical connection system of claim 5, wherein the mating feature includes at least a recessed portion, and a stop.

7. The electrical connection system of claim 6, wherein the mating channel includes an elongate spring with an engagement end that engages with the recessed portion to movably secure the first terminal module in the module interface.

8. The electrical connection system of claim 7, wherein the header interface includes a protrusion that moves into a void between the engagement end, the stop, and the first terminal module.

9. The electrical connection system of claim 7, wherein the engagement end is configured to be released when the protrusion pushes the engagement end down to move past the stop.

10. The electrical connection system of claim 1, wherein the module interface includes a first lock feature that engages with a corresponding second lock feature of the header interface to lock the module interface to the header interface when the module interface is fully seated on the header interface.

11. The electrical connection system of claim 10, further comprising a connector position assurance (CPA) feature that engages with the first lock feature and the second lock feature to prevent the first and second lock features from disengaging.

12. A method, comprising:
retaining a first terminal module in a module interface;
retaining a second terminal module in the module interface locked in a predefined position in the module interface staggered relative to the first terminal module;
seating the module interface on a corresponding header interface;
mating the first terminal module, thereby releasing the module interface to move relative to the header interface; and
moving the module interface to a fully seated position on the header interface, which mates the second terminal module and engages a lock to secure the module interface to the header interface.

13. The method of claim 12, wherein the first terminal module and the second terminal module each carry a plurality of terminals.

14. The method of claim 12, further comprising:
retaining the second terminal module arranged forward of the first terminal module in the module interface before seating the module interface on the header interface.

15. The method of claim 12, further comprising:
engaging a mating feature of the first terminal module with a mating channel defined in the module interface to release the module interface once the first terminal module is mated.

16. The method of claim 15, wherein the mating feature includes at least a stop and a recessed portion.

17. The method of claim 16, wherein the header interface includes a protrusion that moves into a void between the engagement end, the stop, and the first terminal module.

18. The method of claim 16, wherein the mating channel includes an elongate spring with an engagement end.

19. The method of claim 18, wherein the engagement end is configured to be released when the protrusion pushes the engagement end down so that the engagement end is freed to move past the stop.

20. A module interface, comprising:
a first module channel configured to retain a first terminal module in the first terminal channel; and
a second module channel configured to retain a second terminal module in the second terminal channel, locked in a predefined position staggered relative to the first terminal module in the module interface;
wherein the module interface is configured to be arranged on a header interface, and moved relative to the header interface until the first terminal module is mated;
wherein the module interface is configured to be released once the first terminal module is mated and moved to a fully seated position on the header interface, which mates the second terminal module and locks the module interface to the header interface.
